(19) United States
(12) Patent Application Publication
(10) Pub. No.: US 2024/0273796 A1
(43) Pub. Date: Aug. 15, 2024

(54) Animated Image File Generation

(71) Applicant: eBrands Innovations, LLC, Phoenix, AZ (US)

(72) Inventor: Alex Edson, Scottsdale, AZ (US)

(21) Appl. No.: 18/439,585

(22) Filed: Feb. 12, 2024

Related U.S. Application Data
(60) Provisional application No. 63/484,482, filed on Feb. 11, 2023.

(51) Int. Cl. G06T 13/00

(52) U.S. Cl. CPC G06T 13/00

(57) ABSTRACT

Techniques are provided for generating animated image files. In one embodiment, the techniques involve receiving a request for an animated image file, receiving an image selection and text instructions, generating a storyboard based on the text instructions, generating a multi-modal prompt based on the image selection and the storyboard, generating multiple images based on the multi-modal prompt, and generating the animated image file based on the multiple images.

### BACKGROUND

The present disclosure relates to generating animated image files, and more specifically, to using generative artificial intelligence (AI) to generate animated image files based on multi-modal prompts.

An animated image file is a sequence of images that makes objects depicted in the animated image file appear to be in motion when displayed on an electronic device. Conventional techniques for generating an animated image file involve using image editing software to compile a sequence of images into a single image file. However, generating animated image files can be time-consuming and may require expertise with image editing software.

### BRIEF SUMMARY OF INVENTION

A method is provided according to one embodiment of the present disclosure. The method includes receiving a request for an animated image file; receiving an image selection and text instructions; generating a storyboard based on the text instructions; generating a multi-modal prompt based on the image selection and the storyboard; generating multiple images based on the multi-modal prompt; and generating the animated image file based on the multiple images.

A system is provided according to one embodiment of the present disclosure. The system includes a processor; and memory or storage comprising an algorithm or computer instructions, which when executed by the processor, performs an operation that includes: receiving a request for an animated image file; receiving an image selection and text instructions; generating a storyboard based on the text instructions; generating a multi-modal prompt based on the image selection and the storyboard; generating multiple images based on the multi-modal prompt; and generating the animated image file based on the multiple images.

A computer-readable storage medium having computer-readable program code embodied therewith, the computer-readable program code executable by one or more computer processors to perform an operation, is provided according to one embodiment of the present disclosure. The operation includes receiving a request for an animated image file; receiving an image selection and text instructions; generating a storyboard based on the text instructions; generating a multi-modal prompt based on the image selection and the storyboard; generating multiple images based on the multi-modal prompt; and generating the animated image file based on the multiple images.

### BRIEF DESCRIPTION OF DRAWINGS

FIG. 1 illustrates a computing environment, according to one embodiment.

FIG. 2 illustrates an animated image file generation environment, according to one embodiment.

FIG. 3 illustrates a flowchart of a method of generating an animated image file, according to one embodiment.

FIGS. 4A-4S illustrate an example of operating a messaging application, according to one embodiment.

FIGS. 5A-5E illustrate angles of motions of an animated image file, according to one embodiment.

FIG. 6 illustrates a process of extracting frames from an animated image file, according to one embodiment.

FIG. 7 illustrates a conversion of the extracted frames to a text description, according to one embodiment.

FIG. 8 illustrates an image separation model process that generates layered images, according to one embodiment.

FIG. 9 illustrates an image separation model process that generates angle tracking data, according to one embodiment.

FIG. 10 illustrates a conversion of extracted frames to text descriptions of differences between the extracted frames, according to one embodiment.

FIG. 11 illustrates a conversion of extracted frames to a multi-layer image with semi-transparent objects, according to one embodiment.

FIG. 12 illustrates a conversion of a multi-layer image with varying opacities to a text description of motion depicted by the semi-transparent objects, according to one embodiment.

FIG. 13 illustrates a storyboard generation, according to one embodiment.

FIG. 14 illustrates a model output prompt generation based on a storyboard, according to one embodiment.

FIGS. 15A-15C illustrate an operation of a messaging application with an animated image file, according to one embodiment.

### DETAILED DESCRIPTION OF THE EMBODIMENTS

Embodiments of the present disclosure improve upon animated image generation by providing an animated image generation (AIG) module that generates an animated image file based on a picture selection and text instructions of a user. In one embodiment, the AIG module forms a multi-modal prompt based on the picture selection and the text instructions, or a storyboard based on the text instructions. A generative AI model may subsequently be used to create multiple images based on the multi-modal prompt. Afterward, the AIG module may compile the multiple images from the generative AI model, and output a corresponding animated image file.

One benefit of the disclosed embodiments is to improve time and labor efficiency in creating animated image files.

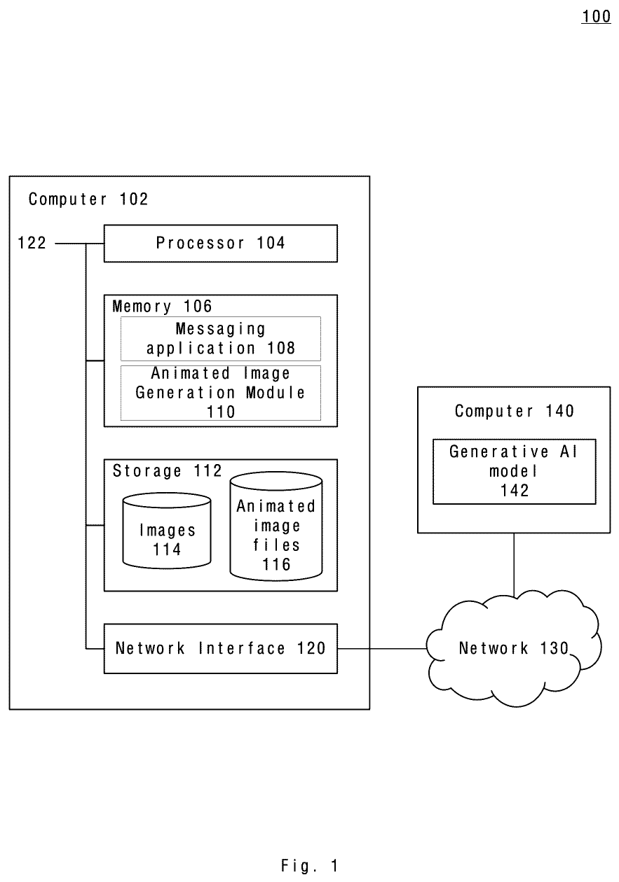

FIG. 1 illustrates a computing environment 100, according to one embodiment. In the illustrated embodiment, the computing environment 100 includes computer 102, network 130, and computer 140.

The computers may be representative of electronic devices, e.g., controllers, desktop computers, distributed databases, laptop computers, mobile devices, servers, tablet devices, web-hosts, or the like. In one embodiment, computer 102 includes a processor 104 that obtains instructions and data via a bus 122 from a memory 106 or storage 112. Not all components of the computer 102 are shown. The computer 102 is generally under the control of an operating system (OS) suitable to perform or support the functions or processes disclosed herein. The processor 104 may be a programmable logic device that performs instruction, logic, and mathematical processing, and may be representative of one or more CPUs. The processor may execute one or more algorithms, instruction sets, or applications in the memory 106 or storage 112 to perform the functions or processes described herein.

The memory 106 and storage 112 may be representative of hard-disk drives, solid-state drives, flash memory devices, optical media, and the like. The storage 112 may also include structured storage, e.g., a database. In addition, the memory 106 and storage 112 may be considered to include memory physically located elsewhere. For example, the memory 106 and storage 112 may be physically located on another computer communicatively coupled to the computer 102 via the bus 122 or the network 130.

Computer 102 may be connected to other computers, e.g., computer 140, via a network interface 120 and the network 130. Computer 140 may include a generative AI model 142. The generative AI model 142 may be hosted locally or accessed remotely. For instance, the generative AI model 142 may be hosted on-device, or hosted on a remotely accessed server via an application programmable interface (API).

Examples of the network 130 include electrical busses, physical transmission cables, optical transmission fibers, wireless transmission mediums, routers, firewalls, switches, gateway computers, edge servers, a local area network, a wide area network, a wireless network, or the like. The network interface 120 may be any type of network communications device allowing the computer 102 to communicate with computers and other components of the computing environment 100 via the network 130.

In the illustrated embodiment, the memory 106 includes a messaging application 108 and an animated image generation (AIG) module 110. In one embodiment, the AIG module 110 represents one or more algorithms, instruction sets, software applications, or other computer-readable program code that may be executed by the processor 104 to perform the functions, operations, or processes described herein.

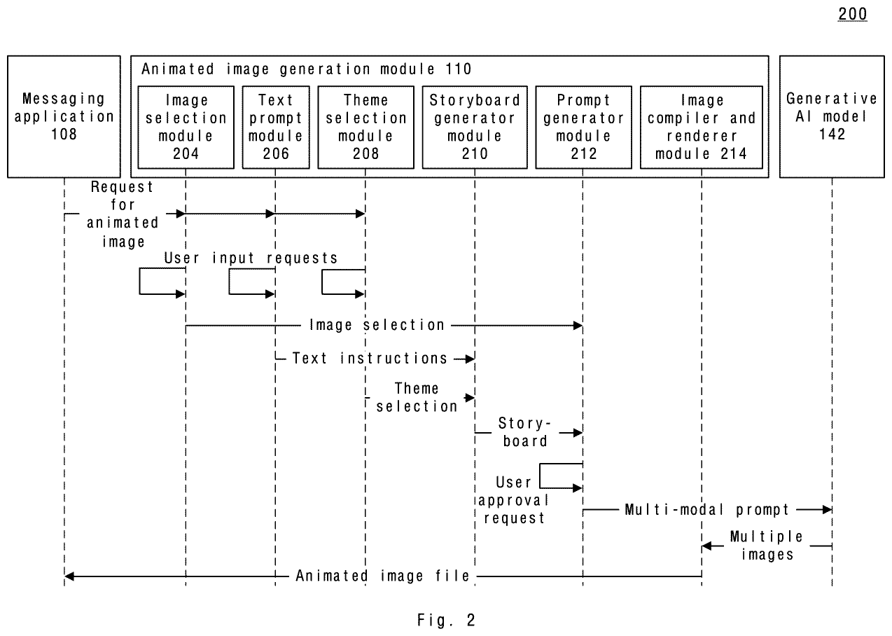

In one embodiment, a user initiates a request for an animated image file via the messaging application 108. The messaging application 108 transfers the request to the AIG module 110, which generates a multi-modal prompt based on an image selection, e.g., an image, an animated image file, or the like, from the images database 114 hosted on the storage 112, and text instructions submitted by the user. A generative AI model may use the multi-modal prompt to generate multiple images, which the AIG module 110 may compile into the animated image file. The animated image file may be stored in the animated image files database 116 hosted on the storage 112. This process is described further in FIGS. 2-3 herein.

FIG. 2 illustrates an animated image file generation environment 200, according to one embodiment. FIG. 3 illustrates a flowchart of a method 300 of generating an animated image file, according to one embodiment. FIG. 2 is explained in conjunction with FIG. 3.

The embodiment illustrated in FIG. 2 depicts data transfers between the messaging application 108, the animated image generation (AIG) module 110, and the generative AI model 142 when generating an animated image file. In one embodiment, the messaging application 108 may be a software application that uses a short message service protocol, a media message service protocol, or the like. The animated image file may include a sequence of images that depicts a visual element of the images as changing or moving over time. Examples of the animated image file include animated scalar vector graphics may include animated scalar vector graphics, animated raster images, animated portable network graphics, HyperText Markup Language 5 files, cascading style sheet animations, or the like.

The generative AI model 142 may represent artificial intelligence models, techniques, and algorithms that generate new data, e.g., images, that is statistically similar to training data used to train the model. Examples of architectures of the generative AI model 142 include generative pre-trained transformers (GPTs), generative adversarial networks (GANs), variational autoencoders (VAEs), autoregressive models such as recurrent neural networks (RNNs) or transformers, or the like.

The method 300 begins at block 302. In one embodiment, a user initiates the request for the animated image file via the messaging application 108 on a mobile device. For example, the user may initiate the request by selecting an option to generate the animated image file from a messaging window or view of a text message conversation displayed on the messaging application 108.

At block 304, the AIG module 110 receives a request for an animated image file. As illustrated in FIG. 2, the request for the animated image file may be transferred to the image selection module 204, the text prompt module 206, or the theme selection module 208 of the AIG module 110.

In one embodiment, upon receiving the request for the animated image file, the aforementioned modules may generate one or more prompts that accept user input. The user input may include an image selection, text instructions, or a theme selection. The one or more prompts may be transferred to the messaging application 108, and displayed on the mobile device.

At block 306, the AIG module 110 receives an image selection and text instructions. In one embodiment, the user may respond to the prompts by selecting an image from an image library and by inputting at least one text instruction written in natural-language. The image library may be hosted on the mobile device or on another computer. In this instance, the text instructions may include a natural-language description of a modification to a visual element of the selected image. For example, the user may select an image of a cat typing on a computer, and input text instructions such as, “Change the background to blue-colored pixel art and put an astronaut helmet on the cat.”

In another embodiment, the user responds to the prompts by inputting text instructions without an image selection. In this instance, the text instruction may include a natural-language description of the requested animated image file. For example, the text instructions may state, “A cat typing on a computer keyboard wearing an astronaut helmet, with pink-colored pixel art in the background.”

In one embodiment, the user may provide additional information to the prompt by optionally selecting a theme, which sets a desired or expected color scheme of the requested animated image file. In one embodiment, the theme may be selected from a graphical representation of an emotion or a concept (e.g., emojis, icons, symbols, or the like) presented in the prompts. For example, the user may select an emoji representing anger or sadness, which may set a respective red-based or gray-based color scheme for the animated image file.

As illustrated in FIG. 2, the messaging application 108 may transfer a user response of an image selection to the image selection module 204, transfer a user response of text instructions to the text prompt module 206, and transfer a user response of a theme selection to the theme selection module 208. Further, when the user response includes an image selection, the image selection, i.e., the image selected by the user, may be transferred to a prompt generator module 212 of the AIG module 110.

At block 308, the AIG module 110 generates a storyboard based on the text instructions. The storyboard may represent text descriptions or questions of features, e.g., visual elements, actions, changes, events, or the like, of the animated image described in the text instructions. In one embodiment, the storyboard may be generated by the generative AI model 142 using an input prompt that includes the text instructions of the user and instructions to the generative AI model 142 to generate questions about the inputted text instructions of the user. Additional text descriptions or questions of the storyboard may be generated via a model-chaining process that uses an output of one model as an input of another model, or the same model. In one embodiment, the prompt may optionally indicate descriptions of moods, colors, emotions, or the like, that are associated with the theme selection. It is to be understood by one of ordinary skill in the art that “model-chaining” refers to using at least part of the output from one model as the input for another model, or the same model again.

In one embodiment, the image selection by the user may be an animated image file, which is transferred to the generative AI model 142. The generative AI model 142 may perform an image separation process to separate individual frames of the image selection, and then output text descriptions of the individual frames. The generative AI model 142 may output the text descriptions using an image-to-text model trained on a dataset of images with corresponding captions. In one embodiment, the image-to-text model may be a neural network that includes an image encoder and a text decoder. The image encoder may process an individual frame and extract a feature representation of the frame. The text decoder may then use the feature representation to generate a natural-language text description of the frame. Alternatively, text descriptions may be determined, as described in block 312 below.

The text descriptions of the individual frames may be transferred to a storyboard generator module 210 of the AIG module 110 as text instructions and used as described herein. In addition, the image-to-text model may be further trained via an unsupervised learning process using the mapping of the individual frames to corresponding text descriptions.

As illustrated in FIG. 2, the storyboard generator module 210 may transfer the storyboard to the prompt generator module 212 of the AIG module 110.

At block 310, the AIG module 110 generates a multi-modal prompt based on the image selection and the storyboard. In one embodiment, the multi-modal prompt represents a machine learning input that includes multiple forms of data, such as text, images, videos, or the like.

In one embodiment, the prompt generator module 212 transfers the multi-modal prompt to the messaging application 108. Afterward, the messaging application 108 may display the multi-modal prompt for user approval. Upon receiving user approval, the messaging application 108 may transfer the approval to prompt generator module 212, which transfers the multi-modal prompt to the generative AI model 142.

At block 312, the AIG module 110 may generate multiple images based on the multi-modal prompt. In one embodiment, when the multi-modal prompt includes an animated image as the image selection, e.g., a GIF file, the generative AI model 142 may perform an image segmentation process to separate each frame of the animated image to isolate features of the frames into separate layers of a multi-layer image, for example, by using a convolutional neural network (CNN) or a transformer.

Continuing the previous examples, the generative AI model 142 may use a CNN to identify the front legs of the cat typing on a keyboard, and place each of the front legs into separate layers of a multi-layer image. Similarly, the keyboard, the background, and any changes to the features throughout the frames may also be captured in separate layers of the multi-layer image. Afterward, the generative AI model 142 may apply one or more computer vision algorithms to identify positions or angles, e.g., azimuth, elevation, rotational, etc., of the features of each layer. In one embodiment, the generative AI model 142 may output a natural-language description of the identified feature positions and angles.

Continuing the previous examples, the generative AI model 142 may output, “A black cat wearing a space helmet is typing on a laptop positioned on a wooden desk. Each of the cat's paws move up and down in alternating directions according to the following details. With respect to frame no. 1 relative to frame no. 2: the angle of the cat's left paw increases by 4 degrees (−16 degrees to −12 degrees), and the angle of the cat's right paw decreases by 7 degrees (15 degrees to 8 degrees). With respect to frame no. 2 relative to frame no. 3: the angle of the cat's left paw increases by 21 degrees (−12 degrees to 9 degrees), and the angle of the cat's right paw decreases by 31 degrees (8 degrees to −23 degrees). With respect to frame no. 3 relative to frame no. 4: the angle of the cat's left paw decreases by 26 degrees (9 degrees to −17 degrees), and the angle of the cat's right paw increases by 19 degrees (−23 degrees to −42 degrees).”

In another embodiment, the generative AI model 142 may generate a single, composite image, where differences between successive frames of the animated image are depicted as semi-transparent overlays of differing opaqueness on the composite image. The generative AI model 142 may be pre-trained to correlate levels of semi-transparency to motion of a visual element of the composite image. Therefore, when such a composite image is input into the generative AI model 142, the generative AI model 142 may generate a description of each frame as described above.

In one embodiment, natural-language descriptions output by the generative AI model 142 may be sent to the messaging application 108 for user approval, or further modification. For instance, the user may input text instructions to change an angle or position of a described feature. The approved or modified natural-language text output of the generative AI model 142 may be re-used by the same generative AI model 142 or inputted into another model to generate the animated image file.

In one embodiment, when the multi-modal prompt includes a static image, i.e., a non-animated image, as the image selection, the generative AI model 142 may use an image-to-image model to generate a second image based on the first image, a third image based on the second image, and so forth. In one embodiment, the image-to-image model may be a neural network that is trained to convert an input image into a desired output image. Image-to-image models may implement CNNs or transformers to process the input image, as well as another modality, such as the text instructions of the user, to generate the output image.

As illustrated in FIG. 2, the generative AI model 142 may generate multiple images based on the multi-modal prompt. The multiple images may subsequently be transferred to an image compiler and renderer module 214 of the AIG module 110.

At block 314, the AIG module 110 may generate the animated image file based on the multiple images. In one embodiment, the image compiler and renderer (ICR) module 214 compiles the multiple images in sequence to generate the animated visual file, such that when the animated visual file is rendered, a visual element of the animated visual file appears to be changing or moving over time.

As illustrated in FIG. 2, the ICR module 214 may transfer the compiled animated image file to the messaging application 108 to be displayed to the user. In one embodiment, the user may approve of the animated image file, or input instructions to modify the animated image file. When the user inputs instructions to modify the animated image file, the file may be updated using processes similar to the processes described at block 312. This process may repeat until the user approves of an animated image file. The method 300 ends at block 316.

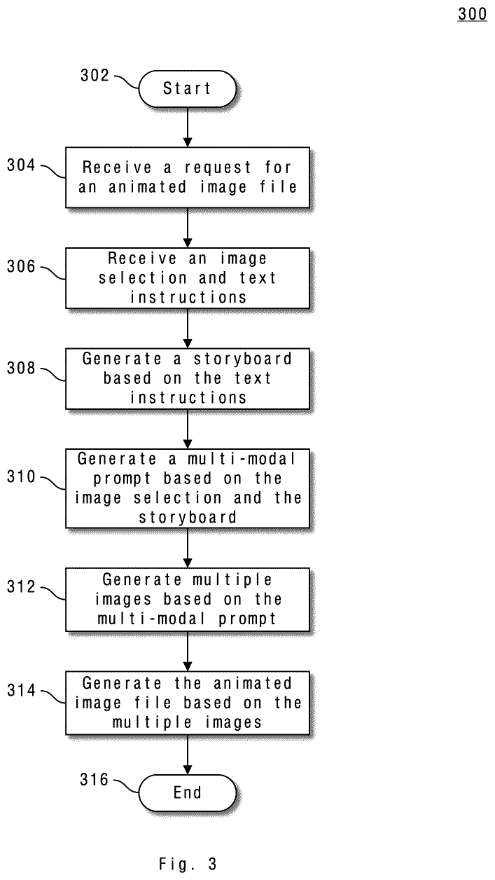

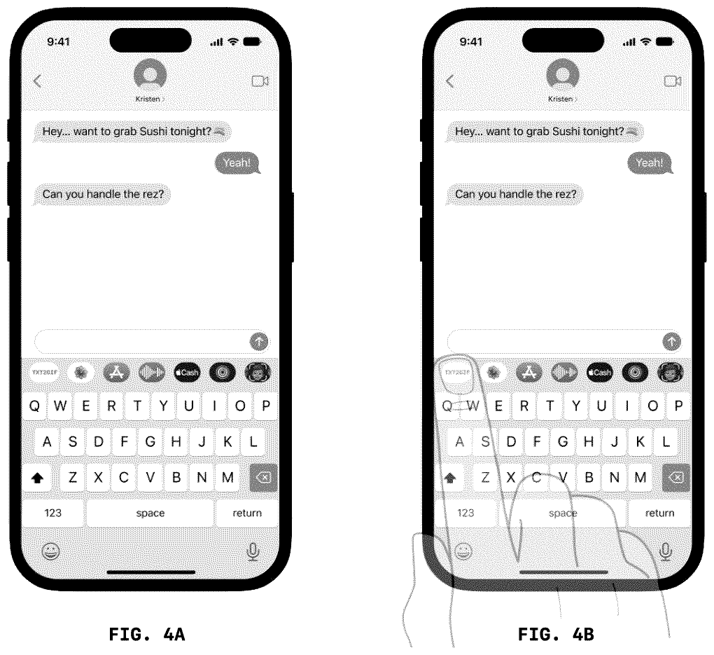

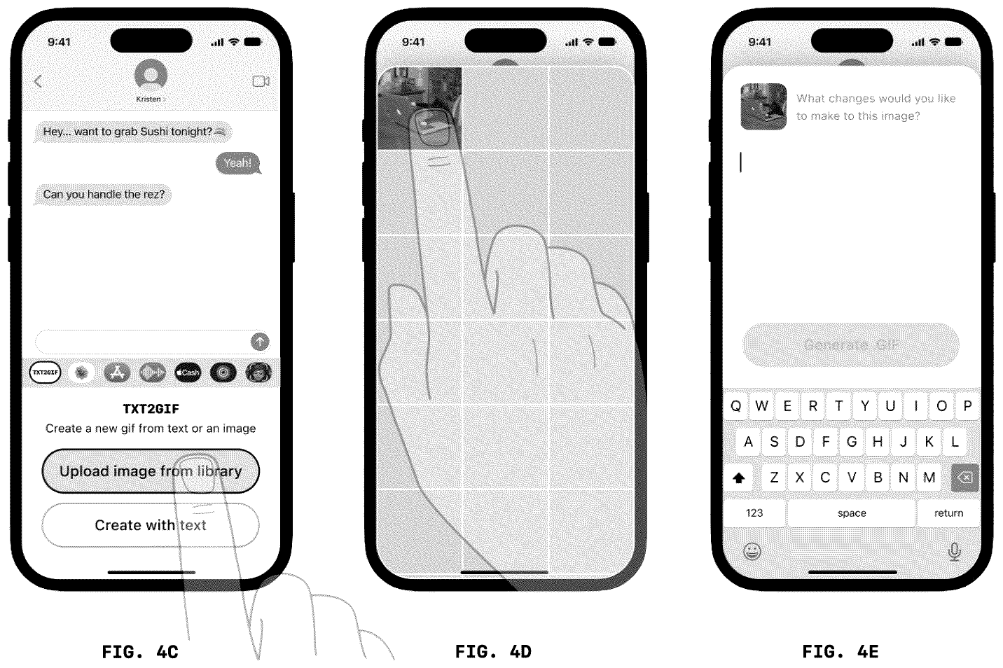

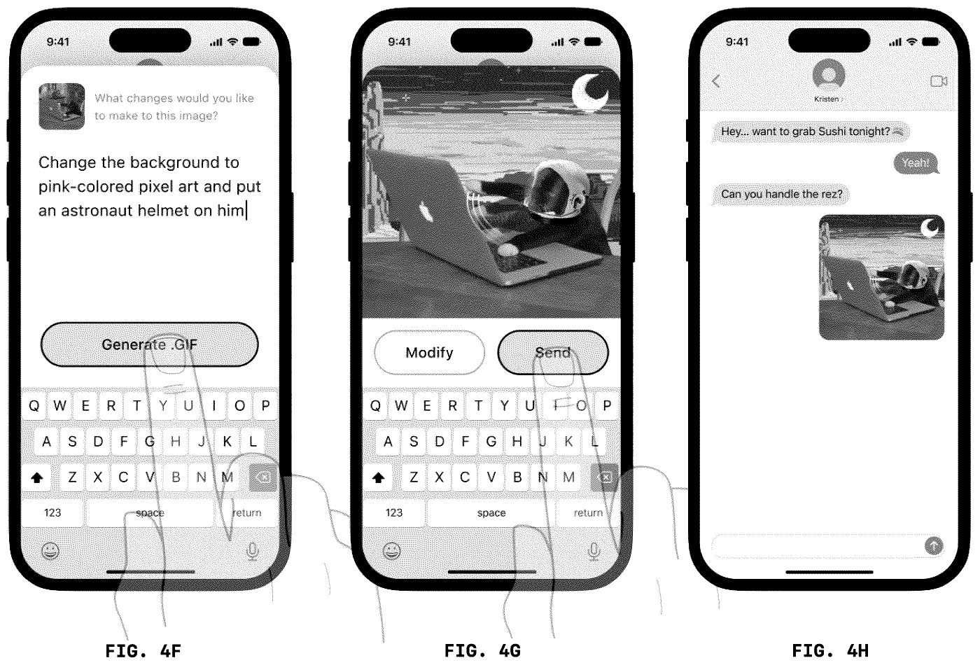

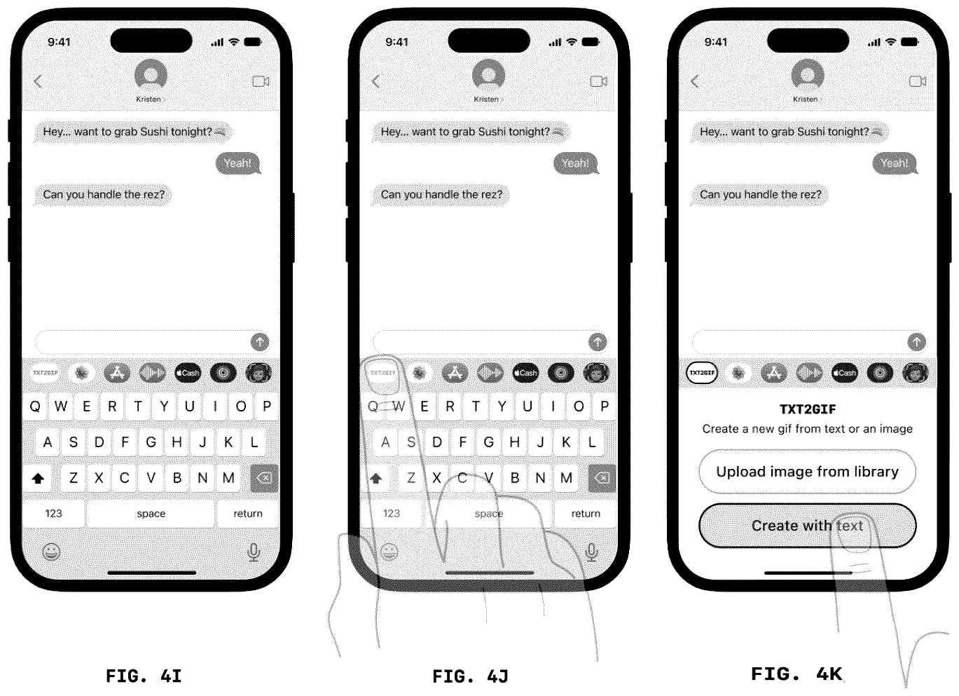

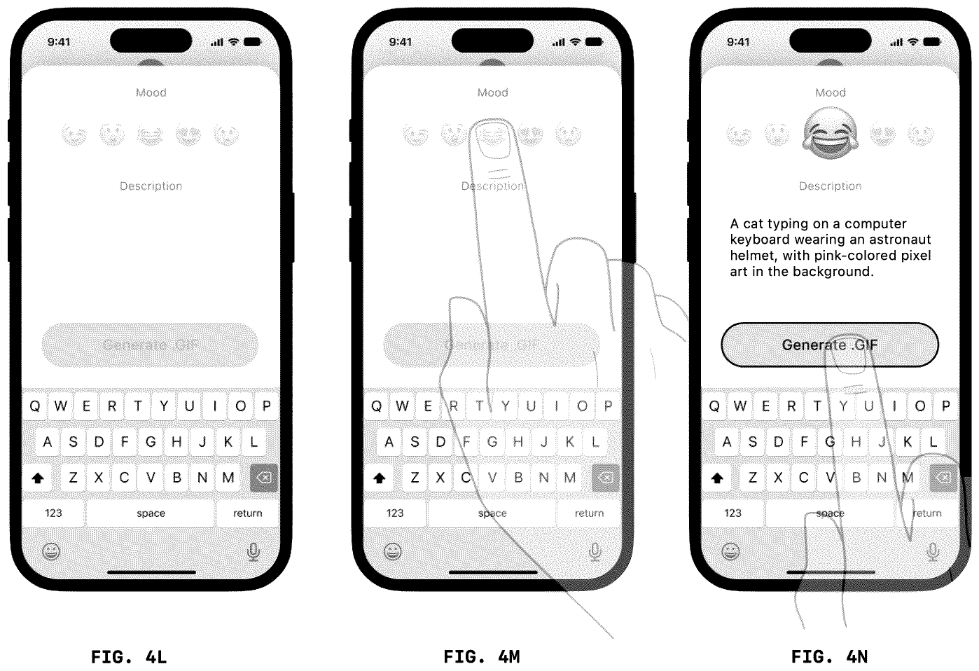

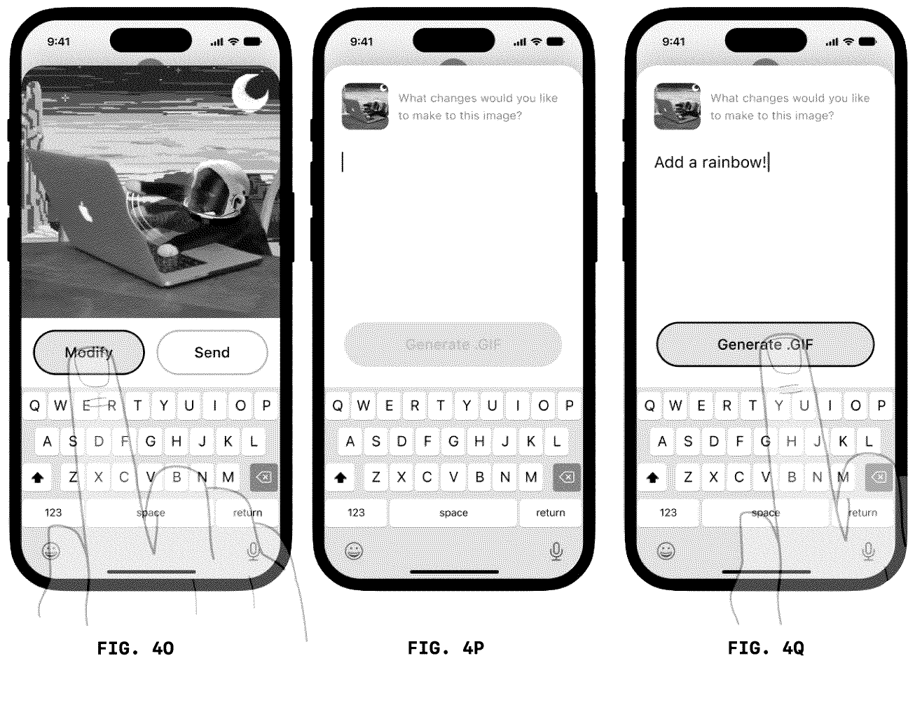

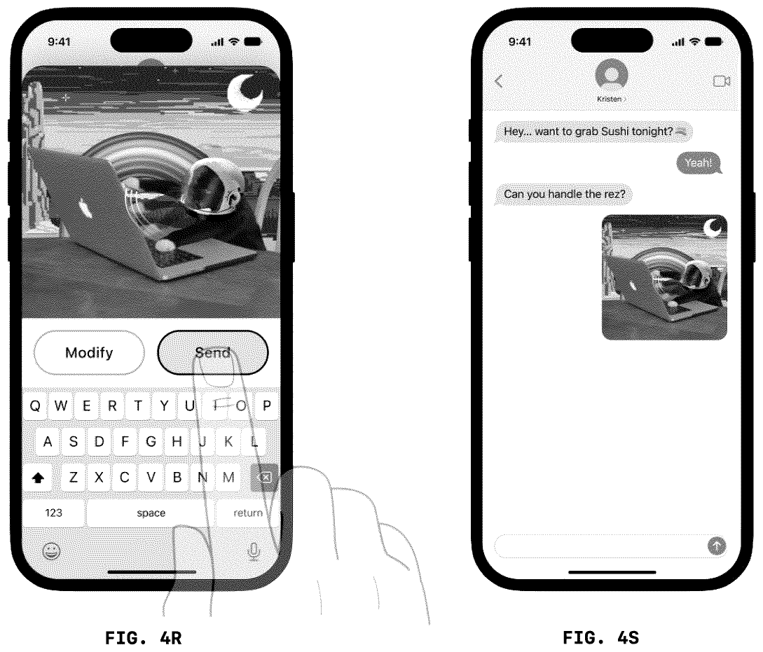

FIGS. 4A-15C illustrate an example of operations described herein.

FIG. 4A is an illustration of a user interface depicting an instant messaging app, in which the user may communicate with other users with short message service (SMS) text messages, media message service (MMS) messages, rich-text service (RCS), or any other messaging communications protocol, e.g., end-to-end encrypted protocols. The messaging app protocols may include short message service (SMS), media messaging service (MMS), rich-text service (RCS), end-to-end encrypted protocols, and/or other protocols. The messaging may include sending text messages, emojis, images, graphics, and/or other content. Images may include a variety of protocols, including photographs, graphics, and animated image files, e.g., graphic interchange format (.gif). Other animated image file formats may be utilized in accordance with the principles described herein. Such other animated image file formats may include Animated SVG, Animated WebP images, APNG-animated PNG images, HTML 5 (WebM, H264, Theora), CSS3 animations (CSS motion pass).

In the context of text-to-image models, a text prompt is a string of text that is used to guide a generative artificial intelligence (AI) model to produce an image. The text prompt may provide a description of the content that should be generated, such as the objects to be presented within the image or the animated image file, the background, and other aspects of the overall scene. The model then uses this text prompt as an input and generates an image that corresponds to the provided description. The model output, i.e., the generated image, may also be referred to as a “synthesized” image.

In the context of prompt engineering, multi-modal prompts may increase the output accuracy of a machine-learning model by providing additional information. For example, a text prompt may detail the type of objects and associated attributes that should appear in an image, e.g., “a cat typing on a computer,” whereas a prompt containing media, such as an image, may provide helpful visual context about the placement and relationship of those objects and associated attributes, e.g., resolving potential questions, such as “What should be the angle of the camera depicting the cat typing on the computer?”.

With regard to FIG. 4A, the user of the electronic device is asked, “Hey . . . want to grab Sushi tonight?” by another user of a messaging application. The user responds in the affirmative, replying, “Yeah!” In response to the user agreement with sushi for dinner, the other user asks whether or not the user may handle the reservation, stating, “Can you handle the rez?”. Rather than responding with another text-based reply, the user opens a “TXT2GIF” application, enabling the user to generate animated image files from within message. In this example, TXT2GIF is an application that performs operations set forth in embodiments herein.

With regard to FIGS. 4A-B, an illustration of the user opening the TXT2GIF application is depicted. As shown, the application may be a third-party application accessible within a messenger application.

With regard to FIG. 4C, a lower portion of the electronic display depicts the user interface of the TXT2GIF application. Further depicted in FIG. 4C, the user is presented with two buttons. The first button enables the user to upload media, such as an image file from a library (see: “Upload image from library” button) to serve as a reference visual for generating the animated image file. The second button enables the user to generate their animated image file using text prompts (see: “Create with text” button). As indicated, the user selects “Upload image from library”. The library may be locally-based inclusive of animated image files, e.g., photos and videos saved to the user camera roll, a cloud-based library inclusive of animated image files, e.g., a third-party database, which may be accessed via an Application Programming Interface (API), etc.

With regard to FIG. 4D, a locally-based library inclusive of animated image files may be displayed in a matrix-like, i.e., grid, format and/or any other format that enables the user to select one of the image files. In one aspect, the user may select multiple image files. In this case, the user selects one image file (see: upper-left section of the user interface). As depicted in FIG. 4D, the user-selected media may an image selected by tapping a touch-sensitive electronic display. It is to be understood that the selection of visuals is not limited to tapping a touch-sensitive display. For example, users may also select visuals using a mouse cursor and/or any other selector. In this example, the selected image file selected is a static photograph of a cat typing on a laptop.

With regard to FIG. 4E, in response to the user selecting the image file, the user interface displays a text prompt field that enables the user to input instructions in natural-language that may be used to affect edits to the selected image, e.g., photograph, when creating the animated image file. The user may input natural-language instructions by typing, e.g., using an on-screen keyboard, physical keyboard, a transcription function (see: “microphone” button in the lower right of the user interface), etc.

With regard to FIG. 4F, the user has inputted a natural-language text prompt instructing the model to “change the background to pink-colored pixel art and put an astronaut helmet on him” for the animated image file.

After inputting the natural-language instructions, the user may select a “Generate .GIF” button that causes the messaging application to communicate with at least one generative AI model to create the animated image file. In doing so, as further described herein, a multi-modal prompt inclusive of the user-selected image file and user-submitted natural-language text prompt may be communicated to a generative AI model, such as a generative AI model that is either locally-hosted, i.e., on-device, or remotely-accessed, e.g., via an API.

In response to the user selecting the “Generate .GIF” button to generate the animated image file, an animated image file based on the multi-modal prompt, i.e., the user-selected visual prompt and user-inputted text prompt, may be presented to the user. In this case, the animated image includes pixel art background, a cat wearing an astronaut helmet, and the cat's right arm moving up and down so as to represent the user handling the reservation for the sushi restaurant. Because the user is satisfied with the animated image file, the user does not request any modifications and proceeds to send the animated image file to the other user by clicking a button (see: “Send” button).

With regard to FIG. 4G, if the user is dissatisfied with the animated image file generated by the model, the user may input natural-language instructions to be sent to an AI model for modifying the animated image file, e.g., by clicking a button on the user interface (see: “Modify” button), as depicted in FIGS. 4O-4R.

With regard to FIG. 4H, an illustration of the animated image file being sent by the user after clicking the “Send” button shown in FIG. 4G, is depicted.

With regard to FIGS. 4I-4N, illustrations of the electronic device of FIGS. 4A-4H displaying the user interface enabling the user to select a button to produce an animated image file by creating an image using natural-language using a generative AI model without the user selecting a starting image file and optionally select a general theme of the animated image file by selecting a graphical element, such as a “winking face” emoji indicative of affection, are shown. FIG. 4I shows another initiation of a communication from the user in creating an animated image file to respond to the other user. FIG. 4J shows the user selecting the button that enables the user to create the animated image file, in this case, a graphical interchange format (GIF) file. If another type of animated image file were desired, then either the messaging application that generates the GIF file may be configured to output another type of image file, or another messaging application configured to generate a different type of animated image may be available to the user.

With regard to FIG. 4K, an illustration of the user selecting a button titled “Create with text” is depicted. As shown, the button enables the user to create an animated image file by inputting a natural-language text prompt submitted to a generative AI model. The generative AI model capable of generating images from the user-submitted natural-language text prompt may either be the same model or a different model used to affect edits to the user-selected animated image file in generating the animated image file guided by a multi-modal prompt, as described herein. For example, in one aspect, a fine-tuned text-to-image model may be used if the user selects the “Create with text” button shown in FIG. 4A. In a related embodiment, before the user inputs a natural-language text prompt, the application may display multiple user-selectable emojis indicative of the general theme, i.e., mood, that the user desires for the model to convey the animated image file. The emojis may include a “winking face” emoji indicative of affection, a “surprised face” emoji indicative of astonishment, a “laughing face” emoji indicative of humor, a “romantic face” emoji indicative of loveliness, a “sad face” emoji indicative of unhappiness. It is to be understood that additional and/or alternative emojis may be utilized in accordance with the principles described herein.

As shown in FIG. 4M, the user selects the “laughing face” emoji and proceeds to input natural-language instructions for an image to be created by a generative AI model. In this case, the description is “a cat typing on a keyboard wearing astronaut helmet, pink-colored pixel art,” as shown in FIG. 4N. It is to be understood that other details deemed relevant by the user may also be included. Once the user has inputted a natural-language text prompt and selected an emoji, the user may select the “Generate .GIF” button to cause the messaging application to generate an animated image file. In causing the animated image file to be generated, a multi-modal prompt inclusive of the user-selected emoji and natural-language text prompt may be communicated to a generative AI model to generate the image using the selected theme, in this case, a humorous theme. Resulting from the natural-language instructions, a humorous animated image file, such as the one depicted in FIG. 4O, may be generated and subsequently presented to the user on the electronic display in the user interface. The user may also elect to send the animated image file as created or modify the animated image file by selecting a “Modify” button, as depicted in FIG. 4O. In this case, the user selects the “Modify” button, enabling the user to input natural-language instructions to be sent to an AI model for modifying the animated image file, prior to sending, e.g., via the messaging app.

As shown in FIG. 4P, a user interface with a text prompt field may be presented to the user to enable the user to input natural-language instructions for changes to be made to the animated image file. Both the animated image file and a question, e.g., “What changes would you like to make to this image?”, are simultaneously displayed to prompt the user to input natural-language instructions for the modification to be made to the animated image file. As shown in FIG. 4Q, the user inputs natural-language instructions stating, “Add a rainbow!” and proceeds to select the “Generate .GIF” button to cause the animated image file to be modified according to the user's inputted natural-language instructions. In response to the user selecting the button, the messaging application may form and communicate a multi-modal prompt inclusive of the animated image file and natural-language instructions for modification of the animated image file by the generative AI model. After the AI model has completed modifying the animated image file pursuant to the user's instructions, the animated image file may subsequently be presented to the user, as depicted by the addition of the rainbow in FIG. 4R. If the user is satisfied with the modified animated image file, the user may select the “Send” button, as depicted in FIG. 4S. In response to the user selection of the “Send” button, the animated image file may be communicated via the messaging app, e.g., to the other user, representing that the user is making the reservations. It is to be understood that while the accompanying drawings of the present disclosure depict communication of the animated image file from a first user to a second user (e.g., as shown in FIG. 4S), multiple users are not required for generating an animated image file. For example, in one aspect, instead of a first user sending the animated image file to a second user, the first user may also initiate a messaging conversation with their own phone number, i.e., texting the animated image file to their own number.

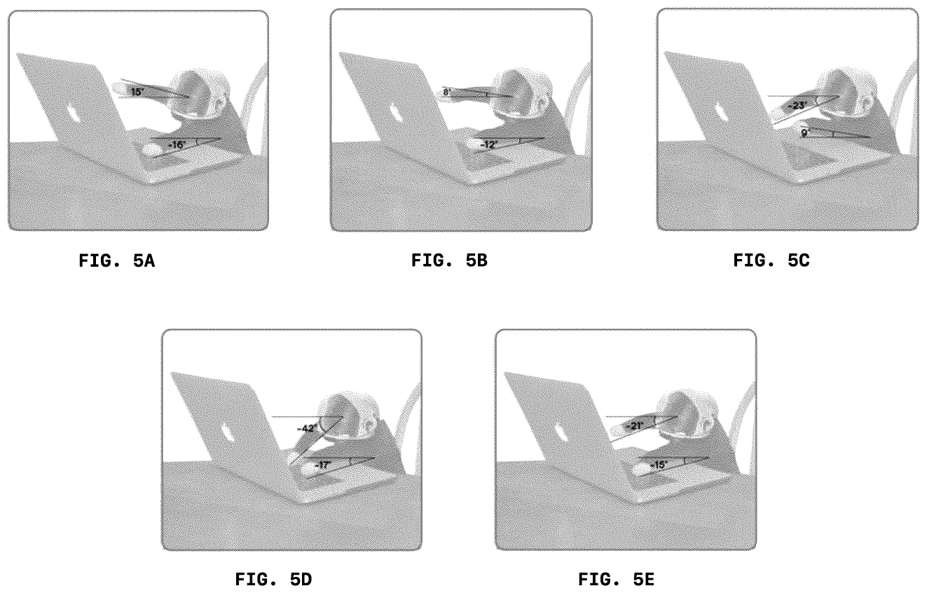

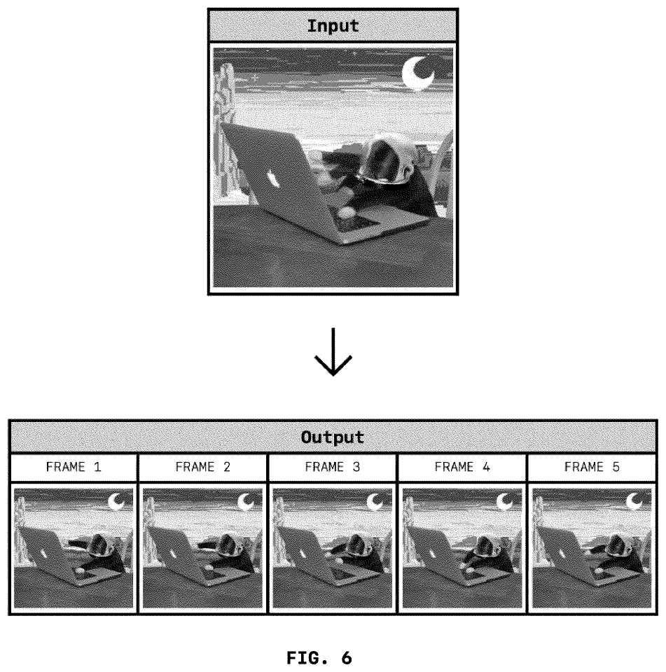

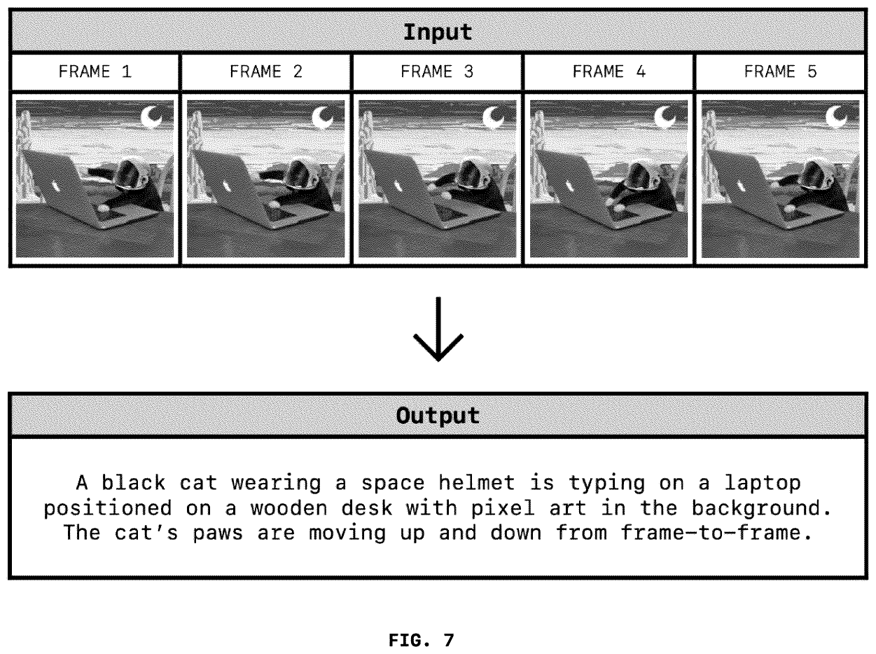

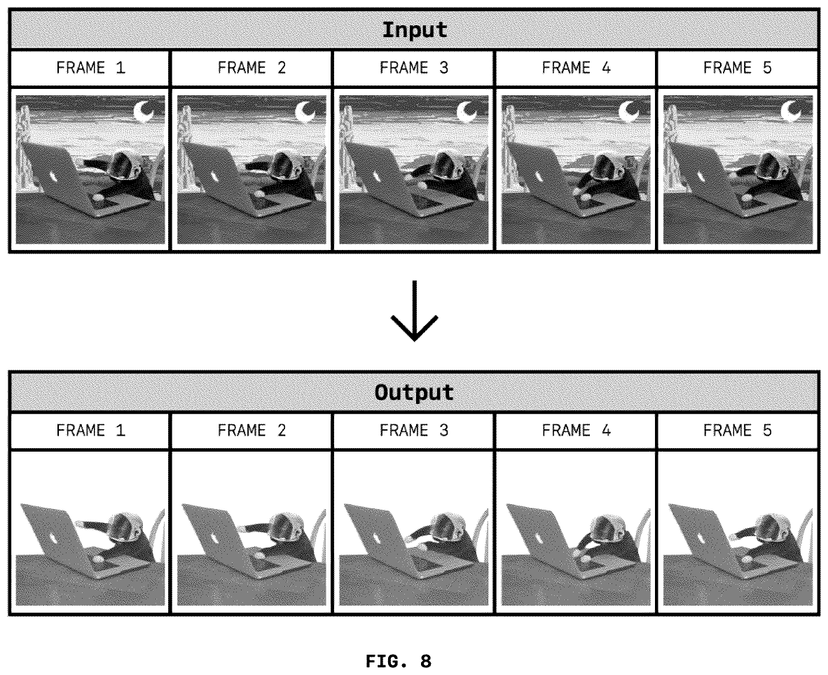

With regard to FIGS. 5A-5E, illustrations of a process depicting the animation of an animated image file to generate an animated image file are shown. The animated image file may be a static image, such as a still photograph, or other form of media. As shown in FIG. 5A, the animated image file is a photograph. In an embodiment, a generative AI model or other image processing module accessible thereby may be configured to use a “magic wand” function or the like to select a feature, and/or portion of a feature, contained in the animated image file to animate. In this case, the generative AI model may identify and select each of the cat's arms and paws independent from other features, such as the cat body, keyboard, desk, etc., using a magic wand function. Additionally, because the generative AI model is able to animate the cat arms, the angles of each of its arms, e.g., +15 degrees and −16 degrees relative to horizontal from the respective shoulders of the cat, the generative AI model may perform the animation of the animated image file to render synthesized images by altering the angle of the arms of the cat using successive angle adjustments, as shown in FIGS. 5B-5E.

In an embodiment, the multi-modal prompt may further include an identifier, e.g., text, representative of a general theme associated with a selected element, e.g., emoji or other graphic. It is to be understood that other information may also be included in the multi-modal prompt. Each of the generated images or synthesized images that are received from the generative AI model may be compiled and rendered by the messaging application, thereby producing the animated image file with each of the synthesized images.

In one embodiment, the multi-modal prompt may include a duplicate animated image file for each of the natural-language instructions to be processed on the image. In another variation, a single animated image file may be included in the multi-modal prompt. The response from the generative AI model may be a synthesized, i.e., generated, image, which may subsequently be inputted into the generative AI model in the next multi-modal prompt to create a new synthesized image. The generative AI model may alter a single image in various ways to create a series of synthesized images that form an animation. For instance, a first synthesized image may show a cat with its arms at one angle, a second synthesized image may rotate the cat arms to a second angle, and so on, resulting in a sequence of synthesized images that make up an animated image, such as a GIF file.

With regard to FIG. 6, an illustration of a GIF-to-JPG (Joint Photographic Experts Group) converter program is depicted, showing what happens after frames are extracted from a GIF file format and presented in a JPG file format is shown. Using a GIF-to-JPG function enables a user to select an animated image file in the form of a GIF, and convert the GIF into a sequence of individual images or frames, in this case, five frames, that form the GIF so that the individual images may be modified, as previously described. For example, each of the individual images of the GIF file may be extracted from the GIF file and presented to the user, or not presented to the user, and modification to one or more of the images of the GIF file may be performed based on the user-submitted natural-language instructions.

With regard to FIG. 7, an illustration of a model depicting the conversion of each extracted frame into a text-based description of each frame is depicted. In one aspect, the model may be fine-tuned by converting an animated image file (e.g., a GIF) into a series of extracted frames which may subsequently be mapped to their corresponding text-based descriptions.

In one aspect, each of the frames extracted from an animated image file may be compiled and rendered into a single image and utilized as input for a fine-tuned model. As shown, the animated image file is that of the cat typing on a keyboard, as previously presented, and from that animated image file, the model generates the text, “[a] black cat wearing a space helmet is typing on a laptop computer positioned on a wooden desk with pixel art in the background. The cat's paws are moving up and down from frame-to-frame.” This text may be presented to the user for further modification or utilized as part of an editing process by submission via a multi-modal prompt along with user-submitted natural-language instructions.

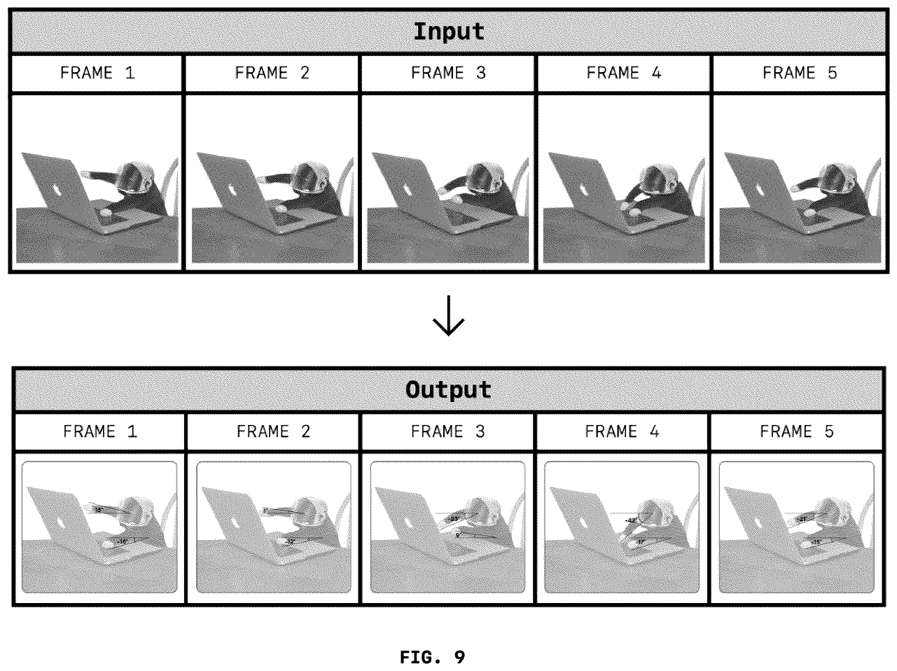

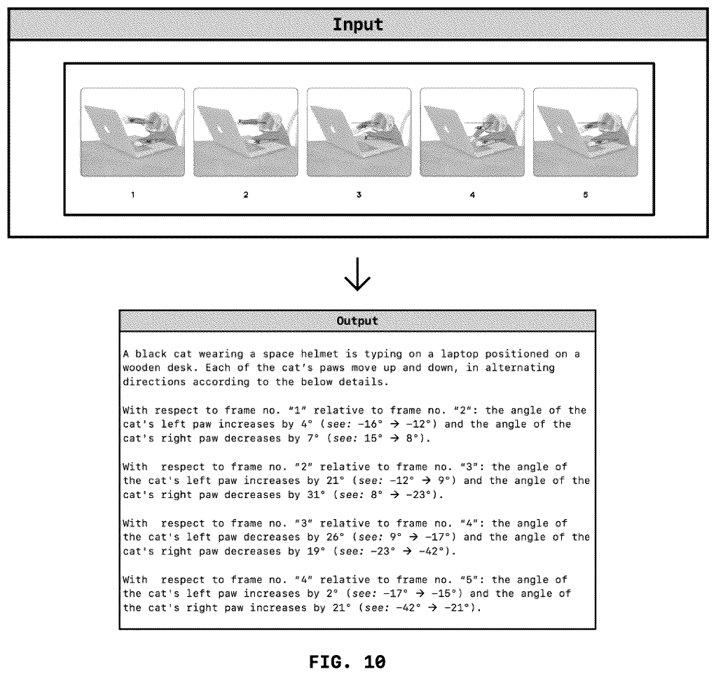

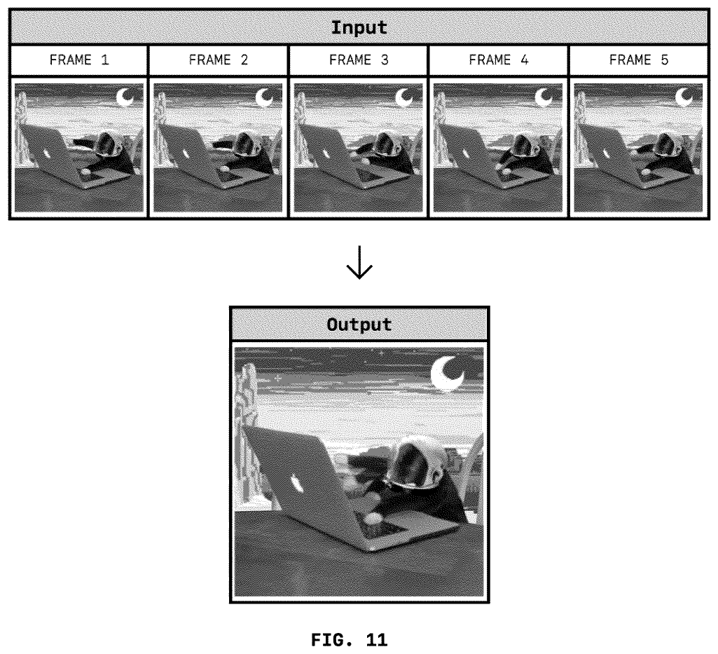

With regard to FIG. 8, an illustration of an image segmentation model depicting how a model may segment select assets into their own layers (see, for example, the legs of the cat moving up and down) is shown. In particular, assets or elements of each of the images of the frames may be identified, selected, and placed onto different layer(s) from other assets. As shown, the assets that are identified, selected, and placed onto one or more layers include the cat, computer, and portion of a chair on which the cat is sitting, and assets that are distinguished include the background, e.g., landscape, sky, moon, etc. Additional image segmentation may be performed on the assets as part of an animation process, such as segmenting the arms of the cat, and each of the arms may be placed onto separate layers or the same layer so that each arm may be repositioned, e.g., angled, as provided in FIGS. 5A-5E and further depicted in FIG. 9.

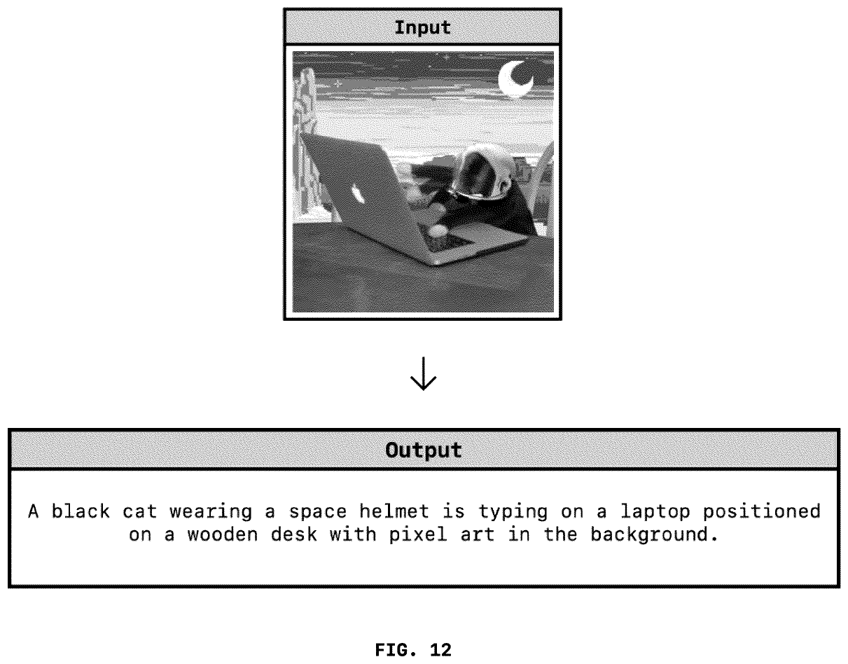

With regard to FIG. 9, an illustration of an image segmentation model depicting how a generative AI model may apply one or more computer vision algorithms to segment at least one object to provide angle-tracking data is depicted. After individual images of an animated image file are segmented, e.g., foreground subject matter separated from background subject matter, the generative AI model may apply the one or more computer vision algorithms to identify angles, e.g., azimuth, elevation, rotational, etc., of each of the segmented features between frames. By identifying relative angles between the frames, e.g., by using one or more models, a description may be produced (see, for example, FIG. 10), along with angular tracking information, which may subsequently be provided to a model, such as a generative AI model, for generating an animated image file.

With regard to FIG. 10, an illustration of a model depicting specific objects from the extracted images are placed into a “comic-strip”-like static image, which are then used as input for an alternative model to describe differences between images as text output is shown. Angles of the cat arms are shown in each of the images, and then natural language text describing changes of the specific objects between sequential static images is shown. For example, between the second and third static images, the model describes “[w]ith respect to frame no. “2” relative to frame no. “3”: the angle of the cat's left paw increases by 21° (see: −12°->9°), and the angle of the cat's right paw decreases by 31° (see: 8°->−23°).” In an embodiment, the description produced by the model may be provided to the user for modification (e.g., to change the angles). In another embodiment, the user may submit an additional natural-language instructions, for example, in the form of a text prompt stating “change the helmet to be a scuba diving helmet.”

In various aspects, an animated image file, such as a GIF file, may be converted into a “storyboard” by utilizing a multi-phase transfer learning approach to convert the animated image file into a natural-language text description, which may be used as a storyboard. For example, if the user uploads a GIF showing a cat typing on a computer, the model may return the result: “a cat facing a computer, at a desk, with each paw moving up and down, on the computer keyboard, in alternating directions, by an angle average of ˜16.3°, in a ‘typing-like motion’ . . . ,” as shown in FIG. 10. One process for creating a storyboard from a GIF file may include:
Step 1: convert a user-inputted GIF file into a series of static images or extracted frames in sequential order using a “GIF-to-JPG converter,” video-to-image program, or other techniques known in the art.
Step 2: utilize a fine-tuned model to convert the extracted frames into text-based descriptions of their depicted content (see, for example, FIG. 6).
Step 3: utilize the output of the model to improve the accuracy of the fine-tuned image segmentation model. Simply put, the description of the image generated by the previous model helps the next model understand which objects to dissect into their own layers. Utilizing this data, the fine-tuned image segmentation model may form segments by separating each asset into its own layer (herein, a “segmented image” or “segmented images”). For example, pixel artwork considered scenery behind the cat (see FIG. 6) may become a segmented image (e.g., layer no. 1), the desk on which the computer is positioned may become another segmented image (e.g., layer no. 2), and so forth. As shown in FIG. 8, the model may also segment each of the cat arms and paws into their own segmented images (e.g., layer no. 3 or layer nos. 3 and 4) to increase the output accuracy of the model, generative AI model, and/or any other model used to perform the process of generating an animated image file from an animated image file of any type.
Step 4: utilize an image-to-image difference model (also known as an “image comparison model”) that compares segmented images of extracted frames against one another and expresses such differences in natural-language (see, for example, FIG. 10). For example, the model may track the angle of the respective paw positions, frame-to-frame, and communicate such changes in natural language (see, for example, “With respect to Extracted Frame no. 1 relative to Extracted Frame no. 2: the angle of the cat's left paw increases by 4° and the angle of the cat's right paw decreases by 7°. With respect to Extracted Frame no. 2 relative to Extracted Frame no. 3: the angle of the cat's left paw increases by 21°, and the angle of the cat's right paw decreases by 31°. [ . . . ]” (see, for example, FIG. 10). By comparing the segmented images of each extracted frame against one another, the model may track the path or difference, e.g., angular, translational, rotational, etc., of individual objects contained within the images. Such data be utilized for expressing motion in natural-language.

In an alternative embodiment, rather than utilizing an image-to-image difference model, each segmented image and/or extracted frame may be layered on top of one another and set varying opacity levels to such layers to create an “onion skinning” effect, as provided with regard to FIG. 12. The onion skinning effect may be utilized as the input of a fine-tuned model for the purpose of illustrating motion as well as detecting differences between separated images from one extracted frame relative to another extracted frame. In another embodiment, each of the extracted images are placed into a single-layer image, e.g., a strip of images, as shown in FIG. 10, and utilize a fine-tuned model for analyzing differences between each of the extracted images.

With further regard to transfer learning, rather than generating an image, duplicating that image multiple times, and affecting edits to each of those duplicated images, an alternative way to create animated image files may be performed using transfer-learning. It is to be understood by one of ordinary skill in the art that this technique, leveraging transfer learning principles, sequentially generates images where each output is used as the input for the next. For instance, a user may input a natural-language text prompt, such as “Generate an image of a cat facing a computer,” which will be used for guiding the generated output of the model. The user may also subsequently instruct the model to modify the image using a natural-language text prompt, such as “Move the cat's left paw to X degree.” The model may subsequently generate an updated image. This revision process may be repeated, for example, until the user is satisfied with the model output. With regard to FIGS. 11-12, illustrations of a model in which the opacity of extracted images from a GIF file may be modified to create a static image depicting an “onion skinning” effect (FIG. 11) that may be utilized as an input by a model to output a text-based description conveying motion (FIG. 12) is depicted. It is to be understood that “onion skinning” is an editing technique used to see several frames of an animation simultaneously. By displaying several opacity-adjusted frames on top of one another, the motion of objects within extracted frames may be conveyed to a model. As shown, after each of the frames with the different angles of the cat arms are synthesized by the generative AI model, an animated image file may be formed by compiling and rendering the synthesized images.

In an embodiment, an onion-skinned output may be utilized as input to a model, as provided in FIG. 12. Moreover, rather than utilizing an image-to-image difference model, each segmented image and/or extracted frame may be layered on top of one another and set varying opacity levels to each of the layers to create an “onion skinning” effect.

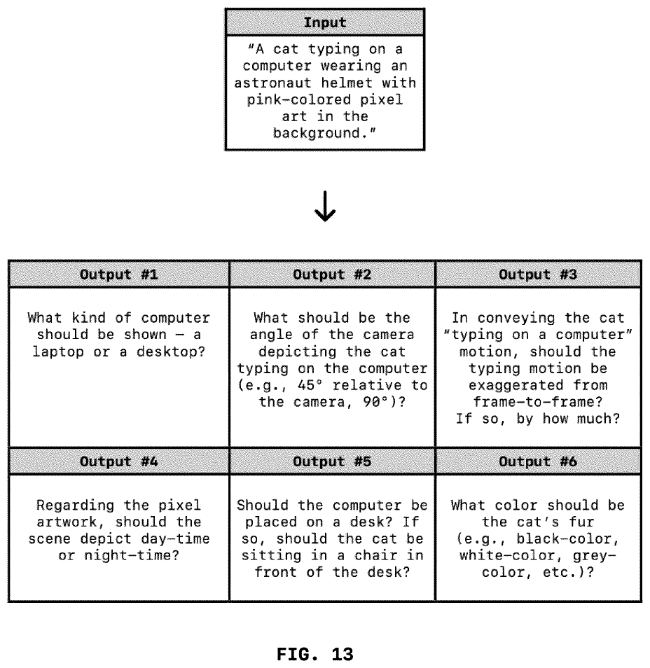

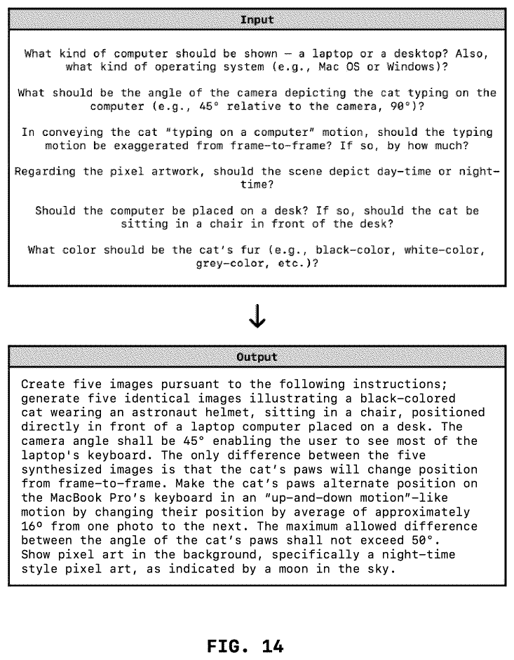

With regard to FIG. 12, a static image depicting an “onion skinning effect” may be fed to a fine-tuned model as input data to generate text-based descriptions conveying motion. Again, the amount of detailed description output from the model may be increased or decreased. For example, rather than generate a text output stating “a cat is typing,” the model may generate a text output that states, “a cat is typing by moving its arms and paws between −18° and +36° (right paw) and −8° and +6° (left paw).” Increasing the accuracy of the model text output may be accomplished by utilizing fine-tuned models in communication with one another, including a text-to-text model, such as the one shown in FIGS. 13-14.

With regard to FIGS. 13-14, the text-to-text model responsible for storyboard generation is depicted, showing how a text prompt with vague details may be converted into a series of model-generated questions, e.g., questions requesting clarification, which may subsequently be fed into another model as input, as further shown in FIG. 14. Specifically, FIG. 14 depicts model-generated text providing answers to the aforementioned model-generated questions. FIG. 13 depicts the conversion of a user's text prompt into a series of model-generated questions which are then fed into a second model, such as the one shown in FIG. 14, which generates answers in response to the model questions. In various aspects, the model-generated answers to its own model-generated questions may be used for improving the user's original text prompt to generate an output with increased accuracy. In an embodiment, the model-generated questions may be synthesized by submitting a prompt to a model, such as a large language model (LLM), comprising of two pieces of text: (1) the user's text prompt, and (2) a natural-language instruction such as “Generate one or more questions, e.g., clarifying questions, using the information by the user describing their request for an animated image.” In another embodiment, the model-generated answers to the model-generated questions may be synthesized by submitting a prompt to a model, such as a large language model (LLM), comprising of two pieces of text: (1) the model-generated questions, and (2) a natural-language instruction such as “Generate answers to the following questions.”

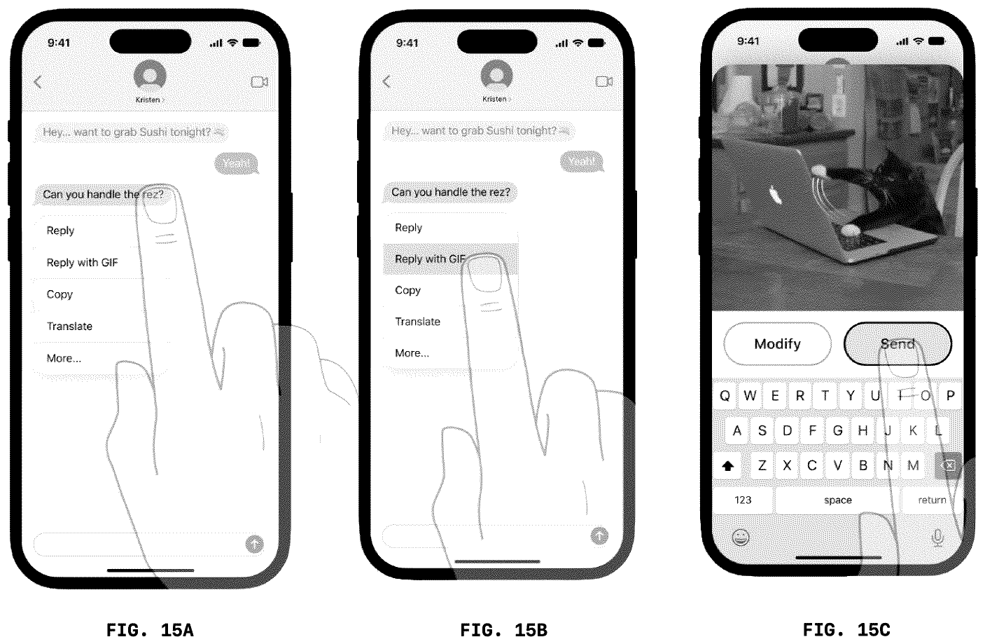

With regard to FIGS. 15A-15C, an illustration of the user replying to an instant message by selecting a dropdown option titled “Reply with GIF,” is depicted. Rather than receive manually inputted natural-language instructions via a text prompt field, natural-language instructions may alternatively be automatically generated by transmitting a message contained in a messenger conversation, such as a group chat. For example, as depicted in FIGS. 15A-C, rather than manually input natural-language instructions via the text prompt field, the user may instead choose a message, such as one exchanged in a group chat between the user and another user, and select a button from a dropdown menu (see: “Reply with .GIF”). Upon selecting the button, the user's selected text message may be submitted to a generative AI model, along with a natural-language instruction, such as “Create a storyboard for a .GIF that will be used to respond to the below text message.” Moreover, the model-generated storyboard may be used as a text prompt, or part of a text prompt, which may be submitted to the same model or another model, such as a text-to-image model. The output of the text-to-image model may subsequently be used as the input, or part of the input, for an image-to-image model. The image-to-image model may generate a second image based on the first image generated (i.e., the image generated by the text-to-image model), a third image based on the second image created by the image-to-image model, and so forth. In one embodiment, the image-to-image model may be a neural network that is trained to convert an input image into a desired output image. The image-to-image model may implement a CNN or transformer to process the inputted image, as well as another modality, e.g., a text instruction, to generate the output images. After generation, the AIG module 110 may compile the multiple generated images from the generative AI model, and output a corresponding animated image file.

The terms “a” and “an” do not denote a limitation of quantity, but rather denote the presence of at least one of the referenced item. The term “or” means “and/or” unless clearly indicated otherwise by context.

Reference is made to embodiments of the present disclosure. However, the scope of the present disclosure is not limited to specific embodiments described herein. It is to be understood that the any combination of features or elements of embodiments the present disclosure are contemplated to implement and practice various embodiments of the present disclosure, whether specifically described herein or not. Descriptions of the present disclosure are merely illustrative and are not considered to be elements or limitations of the appended claim(s) except where explicitly recited in a claim(s). Likewise, reference to the “present disclosure” shall not be construed as a generalization of any inventive subject matter disclosed herein and shall not be considered to be an element or limitation of the appended claim(s) except where explicitly recited in a claim(s).

Aspects of the present disclosure may take the form of an entirely hardware embodiment, an entirely software embodiment (including firmware, resident software, micro-code, etc.), or an embodiment combining software and hardware aspects that may all generally be referred to herein as a “circuit,” a “module,” a “system,” or the like.

The present disclosure may be implemented as a system, a method, a computer program product, or the like. The computer program product may include a computer readable storage medium (or media) having computer readable program instructions thereon that cause a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations or block diagrams of methods, apparatus (systems), and computer program products according to embodiments of the disclosure. It will be understood that each block of the flowchart illustrations or block diagrams, and combinations of blocks in the flowchart illustrations or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions may also be stored in a computer readable storage medium that can direct a computer, a programmable data processing apparatus, or other devices to function in a particular manner, such that the computer readable storage medium having instructions stored therein comprises an article of manufacture including instructions which implement aspects of the function/act specified in the flowchart or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. Some functions may also be repeated, performed in part, or skipped without departing from the invention.

What is claimed is:

1. A method comprising:
receiving a request for an animated image file;
receiving an image selection and text instructions;
generating a storyboard based on the text instructions;
generating a multi-modal prompt based on the image selection and the storyboard;
generating multiple images based on the multi-modal prompt; and
generating the animated image file based on the multiple images.

2. The method of claim 1, wherein the text instructions include a natural-language description of the animated image file.

3. The method of claim 1, wherein the text instructions include a natural-language description of a modification to a visual element of an image corresponding to the image selection.

4. The method of claim 1, wherein the storyboard represents text descriptions or questions of features described in the text instructions, wherein the features represent visual elements, actions, changes, or events of the animated image file, wherein the text descriptions or the questions are generated via a model-chaining process, and wherein the storyboard is further generated based on a theme selection.

5. The method of claim 4, wherein the theme selection includes a graphical representation of an emotion, and wherein the theme selection represents a color scheme of the animated image file.

6. The method of claim 1, wherein the multiple images include a first image and a second image, wherein the first image and the second image are not identical.

7. The method of claim 1, wherein generating the animated image file comprises compiling the multiple images in a sequence that depicts a visual element of the multiple images as changing or moving over time.

8. A system, comprising:
a processor; and
memory or storage comprising an algorithm or computer instructions, which when executed by the processor, performs an operation comprising:
receiving a request for an animated image file;
receiving an image selection and text instructions;
generating a storyboard based on the text instructions;
generating a multi-modal prompt based on the image selection and the storyboard;
generating multiple images based on the multi-modal prompt; and
generating the animated image file based on the multiple images.

9. The system of claim 8, wherein the text instructions include a natural-language description of the animated image file.

10. The system of claim 8, wherein the text instructions include a natural-language description of a modification to a visual element of an image corresponding to the image selection.

11. The system of claim 8, wherein the storyboard represents text descriptions or questions of features described in the text instructions, wherein the features represent visual elements, actions, changes, or events of the animated image file, wherein the text descriptions or the questions are generated via a model-chaining process, and wherein the storyboard is further generated based on a theme selection.

12. The system of claim 11, wherein the theme selection includes a graphical representation of an emotion, and wherein the theme selection represents a color scheme of the animated image file.

13. The system of claim 8, wherein the multiple images include a first image and a second image, wherein the first image and the second image are not identical.

14. The system of claim 8, wherein generating the animated image file comprises compiling the multiple images in a sequence that depicts a visual element of the multiple images as changing or moving over time.

15. A computer-readable storage medium having a computer-readable program code embodied therewith, the computer-readable program code executable by one or more computer processors to perform an operation comprising:
receiving a request for an animated image file;
receiving an image selection and text instructions;
generating a storyboard based on the text instructions;
generating a multi-modal prompt based on the image selection and the storyboard;
generating multiple images based on the multi-modal prompt; and
generating the animated image file based on the multiple images.

16. The computer-readable storage medium of claim 15, wherein the text instructions include one of: a natural-language description of the animated image file, or a natural-language description of a modification to a visual element of an image corresponding to the image selection.

17. The computer-readable storage medium of claim 15, wherein the storyboard represents text descriptions or questions of features described in the text instructions, wherein the features represent visual elements, actions, changes, or events of the animated image file, wherein the text descriptions or the questions are generated via a model-chaining process, and wherein the storyboard is further generated based on a theme selection.

18. The computer-readable storage medium of claim 17, wherein the theme selection includes a graphical representation of an emotion, and wherein the theme selection represents a color scheme of the animated image file.

19. The computer-readable storage medium of claim 15, wherein the multiple images include a first image and a second image, wherein the first image and the second image are not identical.

20. The computer-readable storage medium of claim 15, wherein generating the animated image file comprises compiling the multiple images in a sequence that depicts a visual element of the multiple images as changing or moving over time.
